(19) United States
(12) Patent Application Publication
(10) Pub. No.: US 2010/0296035 A1
(43) Pub. Date: Nov. 25, 2010

(54) DISPLAY SUBSTRATE, METHOD OF MANUFACTURING THE SAME AND DISPLAY DEVICE HAVING THE SAME

(76) Inventors: Jong-Seong Kim, Pohang-si (KR); Sung-Hwan Cho, Hwaseong-si (KR); Ho-Nam Yum, Seoul (KR); Jae-Hyun Kim, Suwon-si (KR); Jung-Woo Park, Seoul (KR); Bong-Sun Seo, Suwon-si (KR); Seong-Chul Hong, Seoul (KR); Seong-Ho Kim, Yongin-si (KR)

Correspondence Address: F. CHAU & ASSOCIATES, LLC, 130 WOODBURY ROAD, WOODBURY, NY, 11797, US

(21) Appl. No.: 12/848,416

(22) Filed: Aug. 2, 2010

Related U.S. Application Data
(62) Division of application No. 11/506,531, filed on Aug. 18, 2006.

(30) Foreign Application Priority Data
Feb. 20, 2006 (KR) 2006-16067

(51) Int. Cl. G02F 1/1335; B05D 5/12

(52) U.S. Cl. 349/113; 427/126.6; 427/122

(57) ABSTRACT

A display substrate includes a transparent substrate, a pixel layer, an organic insulating layer, a transparent electrode and a reflective electrode. The pixel layer is formed on the transparent substrate, and includes a plurality of pixel parts. Each of the pixel parts includes a transmission region and a reflection region. The organic insulating layer is formed on the pixel layer. The transparent electrode is formed on the organic insulating layer corresponding to each of the pixel parts. The reflective electrode is formed on the transparent electrode corresponding to the reflection region. The reflective electrode includes a silver alloy that includes silver (Ag) and impurities having a low solubility in the silver.

### CROSS-REFERENCE TO RELATED APPLICATIONS

This Application is a divisional of U.S. patent application Ser. No. 11/506,531 filed on Aug. 18, 2006, which claims priority to Korean patent application number 2006-16067, filed on Feb. 20, 2006 the contents of which are herein incorporated by reference in their entirety.

### BACKGROUND OF THE INVENTION

1. Technical Field

The present disclosure relates to a display substrate, a method of manufacturing the display substrate, and a display device having the display substrate. More particularly, the present disclosure relates to a display substrate capable of increasing reflectivity.

2. Discussion of the Related Art

A liquid crystal display (LCD) device is generally classified into a transmissive LCD device, a reflective LCD device and a transflective LCD device. The transmissive LCD device displays an image using an artificial light emitted from a backlight assembly that is disposed under an LCD panel. The reflective LCD device displays an image using an ambient light as its light source. The transflective LCD device functions as the transmissive LCD device in a dark place, and functions as the reflective LCD device in a bright place.

Each of the reflective LCD device and the transflective LCD device includes a reflective electrode formed in the LCD panel to reflect the ambient light. The reflective electrode, in general, includes aluminum, an aluminum alloy, etc. Recently, a reflective electrode including highly reflective silver (Ag) has been developed.

### SUMMARY OF THE INVENTION

Embodiments of the present invention provide a display substrate capable of increasing reflectivity, a method of manufacturing the above-mentioned display substrate, and a display device having the above-mentioned display substrate.

A display substrate in accordance with an embodiment of the present invention includes a transparent substrate, a pixel layer, an organic insulating layer, a transparent electrode and a reflective electrode. The pixel layer is formed on the transparent substrate, and includes a plurality of pixel parts. Each of the pixel parts includes a transmission region and a reflection region. The organic insulating layer is formed on the pixel layer. The transparent electrode is formed on the organic insulating layer corresponding to each of the pixel parts. The reflective electrode is formed on the transparent electrode corresponding to the reflection region. The reflective electrode includes a silver alloy that includes silver (Ag) and impurities having a low solubility in the silver.

The impurities may include a metal having a low solubility in the silver. The metal that can be used for the impurities may include aluminum (Al), scandium (Sc), titanium (Ti), vanadium (V), chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), technetium (Te), ruthenium (Ru), rhodium (Rh), palladium (Pd), cadmium (Cd), indium (In), tin (Sn), lanthanum (La), hafnium (Hf), tantalum (Ta), tungsten (W), rhenium (Re), osmium (Os), iridium (Ir), platinum (Pt), gold (Au), mercury (Hg), thallium (Tl), lead (Pb), bismuth (Bi), etc. These can be used alone or in a combination thereof.

The metal may include molybdenum, and an amount of the molybdenum in the silver alloy may be about 1.1 wt % to about 1.5 wt %.

The impurities may include a metal oxide having a low solubility in the silver. The metal oxide may include lithium oxide (LiO₂, Li₂O, Li₂O₂), beryllium oxide (BeO), sodium oxide (NaO₂, Na₂O, Na₂O₂), magnesium oxide (MgO, MgO₂), aluminum oxide (Al₂O₃), calcium oxide (CaO, CaO₂), scandium oxide (Sc₂O₃), titanium oxide (TiO, TiO₂, Ti₂O₃, Ti₃O₅), vanadium oxide (VO, VO₂, V₂O₃, V₂O₅), chromium oxide (CrO₂, CrO₃, Cr₂O₃, Cr₃O₄), manganese oxide (MnO, MnO₂), iron oxide (FeO, Fe₂O₃, Fe₃O₄), cobalt oxide (CoO, Co₃O₄), nickel oxide (NiO, Ni₂O₃), copper oxide (CuO, Cu₂O), zinc oxide (ZnO), niobium oxide (NbO, NbO₂), molybdenum oxide (MoO, MoO₂, MoO₃), palladium oxide (PdO, PdO₂), cadmium oxide (CdO), lead oxide (PbO, PbO₂), etc. These can be used alone or in a combination thereof.

The impurities may include a nonmetal. The nonmetal may include boron (B), carbon (C), silicon (Si), phosphorus (P), sulfur (S), or any combination thereof.

The impurities may include a mixture of a metal and a nonmetal.

A method of manufacturing a display substrate in accordance with an embodiment of the present invention is provided as follows. A pixel layer including a plurality of pixel parts is formed on a transparent substrate. Each of the pixel parts includes a transmission region and a reflection region. An organic insulating layer is formed on the pixel layer. A transparent electrode is formed on the organic insulating layer corresponding to each of the pixel parts. A reflective electrode is formed in the reflection region, and includes a silver alloy that includes silver and impurities having a low solubility in the silver.

A display device in accordance with an embodiment of the present invention includes a display substrate, an opposite substrate facing the display substrate and a liquid crystal layer. The display substrate includes a transparent substrate, a pixel layer, an organic insulating layer, a transparent electrode and a reflective electrode. The pixel layer is formed on the transparent substrate, and includes a plurality of pixel parts. Each of the pixel parts includes a transmission region and a reflection region. The organic insulating layer is formed on the pixel layer. The transparent electrode is formed on the organic insulating layer corresponding to each of the pixel parts. The reflective electrode is formed on the transparent electrode corresponding to the reflection region. The reflective electrode includes a silver alloy that includes silver and impurities having a low solubility in the silver. The liquid crystal layer is interposed between the display substrate and the opposite substrate.

According to embodiments of the present invention, reflectivity of the reflective electrode is increased, and silver atoms may be prevented from cohering to each other, thereby improving image display quality.

### BRIEF DESCRIPTION OF THE DRAWINGS

Exemplary embodiment of the present invention can be understood in more detail from the following descriptions taken in conjunction with the accompanying drawings, in which:

FIG. 1 is a plan view illustrating a display substrate in accordance with an exemplary embodiment of the present invention;

FIG. 2 is a cross-sectional view taken along the line I-I′ shown in FIG. 1;

FIG. 3 is a cross-sectional view illustrating grains of silver;

FIG. 4 is a cross-sectional view illustrating grains of a silver alloy including impurities at a low concentration, which has a low solubility in pure silver;

FIG. 5 is a cross-sectional view illustrating an apparatus for detecting reflectivity of a reflective electrode;

FIG. 6 is a cross-sectional view illustrating a display substrate in accordance with an exemplary embodiment of the present invention; and

FIGS. 7 to 9 are cross-sectional views illustrating a method of manufacturing a display substrate in accordance with an exemplary embodiment of the present invention.

### DESCRIPTION OF THE EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein.

Hereinafter, an embodiment of the present invention will be described in detail with reference to the accompanying drawings.

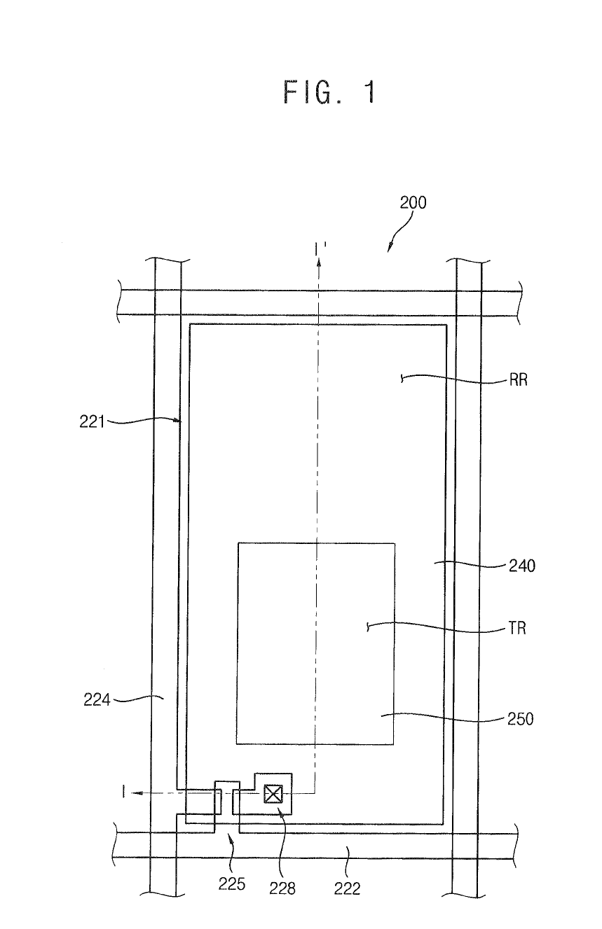

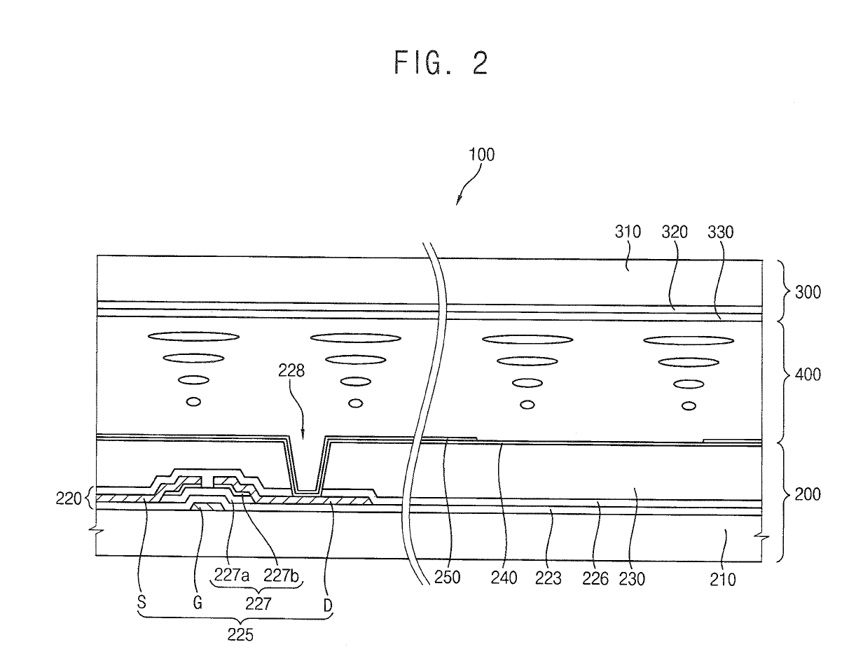

FIG. 1 is a plan view illustrating a display substrate in accordance with an embodiment of the present invention. FIG. 2 is a cross-sectional view taken along the line I-I′ shown in FIG. 1.

Referring to FIGS. 1 and 2, the display device 100 includes a display substrate 200, an opposite substrate 300 and a liquid crystal layer 400. The opposite substrate 300 faces the display substrate 200. The liquid crystal layer 400 is interposed between the display substrate 200 and the opposite substrate 300.

The display substrate 200 includes a reflection region RR and a transmission region TR. An ambient light that is incident into a front side of the display substrate 200 is reflected from the reflection region RR. An artificial light that is emitted from a backlight assembly and disposed under the display substrate 200 passes through the transmission region TR.

The display substrate 200 includes a transparent substrate 210, a pixel layer 220, an organic insulating layer 230, a transparent electrode 240 and a reflective electrode 250.

The transparent substrate 210 includes a transparent material that transmits light. For example, the transparent substrate 210 includes a glass substrate.

The pixel layer 220 is formed on the transparent substrate 210. The pixel layer 220 includes a plurality of pixel parts 221 arranged in a matrix. Each of the pixel parts 221 includes the transmission region TR and the reflection region RR.

The pixel layer 220 includes a gate line 222, a gate insulating layer 223, a data line 224, a thin-film transistor (TFT) 225 and a passivation layer 226. Alternatively, the pixel layer may further include a plurality of gate lines, a plurality of data lines and a plurality of thin-film transistors.

The gate line 222 is formed on the transparent substrate 210, and defines an upper side and a lower side of each of the pixel parts 221.

The gate insulating layer 223 is formed on the transparent substrate 210 having the gate line 222 to cover the gate line 222. The gate insulating layer 223 may include silicon nitride, silicon oxide, etc.

The data line 224 is formed on the gate insulating layer 223, and defines a left side and a right side of each of the pixel parts 221.

The TFT 225 is electrically connected to the gate and data lines 222 and 224. The TFT 225 is formed in each of the pixel parts 221. The TFT applies an image signal that is applied from the data line 224.

The TFT 225 includes a gate electrode G, an active layer 227, a source electrode S and a drain electrode D.

The gate electrode G is electrically connected to the gate line 222, and functions as a gate terminal of the TFT 225.

The active layer 227 is formed on the gate insulating layer 223 corresponding to the gate electrode G. The active layer 227 includes a semiconductor layer 227a and an ohmic contact layer 227b. The semiconductor layer 227a may include amorphous silicon (a-Si) or poly silicon (p-Si). The ohmic contact layer 227b includes an n+ amorphous silicon (n+ a-Si) layer. The ohmic contact layer 227b may be formed by implanting n+ impurities onto an amorphous silicon layer.

The source electrode S is electrically connected to the data line 224, and is extended to a portion of an upper surface of the active layer 227. The source electrode S functions a source terminal of the TFT 225.

The drain electrode D is spaced apart from the source electrode S. The drain electrode D is on a portion of the upper surface of the active layer 227. The drain electrode D functions as a drain terminal of the TFT. The drain electrode D is electrically connected to the transparent electrode 240 through a contact hole 228. The source electrode S is spaced apart from the drain electrode D on the active layer 227 to define a channel of the TFT 225.

The passivation layer 226 is formed on the gate insulating layer 223 having the data line 224 and the TFT 225 to cover the data line 224 and the TFT 225. The passivation layer 226 includes an insulating material. The insulating material may include silicon nitride, silicon oxide, etc.

Each of the gate electrode G, the source electrode S and the drain electrode D of the TFT 225 may have various shapes. In FIGS. 1 and 2, the TFT 225 is an a-Si TFT having the semiconductor layer 227a of amorphous silicon. Alternatively, the TFT 225 may be a polysilicon. TFT having a semiconductor layer of poly silicon.

The organic insulating layer 230 is formed on the pixel layer 220 to planarize a surface of the display substrate 200. The contact hole 228 is formed through the passivation layer 226 and the organic insulating layer 230 and exposes the drain electrode D of the TFT 225.

The transparent electrode 240 is formed on the organic insulating layer 230 corresponding to each of the pixel parts 221. The transparent electrode 240 is electrically connected to the drain electrode D through the contact hole 228.

The transparent electrode 240 includes a transparent conductive material. The transparent conductive material may include indium zinc oxide (IZO), indium tin oxide (ITO), etc.

The reflective electrode 250 is formed on the transparent electrode 240 in the reflection region RR. The reflective electrode 250 defines the reflection region RR from which the ambient light is reflected, and a portion of the transparent electrode 240 that is exposed through an opening of the reflective electrode 250 defines the transmission region TR from which the artificial light emitted from the backlight assembly passes. That is, the artificial light that is emitted from the rear side of the display device 100 passes through the transmission region TR to display the image, and the ambient light that is incident into the front side of the display device 100 is reflected from the reflection region RR to display the image.

The reflective electrode 250 may include a silver alloy including silver (Ag) and impurities that have a low solubility in the silver to increase reflectivity of a reflected light. For example, a thickness of the reflective electrode 250 is about 2,000 Å to about 3,000 Å.

When the reflective electrode 250 includes a silver alloy including silver and impurities that have greater solubility than the silver, the impurities are uniformly distributed between silver atoms. In particular, a binding force between impurity atoms is substantially the same as a binding force between an impurity atom and a silver atom so that the impurity atoms are uniformly distributed between the silver atoms. Thus, the silver atoms may not be prevented from binding to each other to form large silver grains.

However, when the reflective electrode 250 includes a silver alloy including the silver and the impurities that have a low solubility in the silver, impurity atoms bind to each other. In particular, a binding force between the impurity atoms is greater than the binding force between the silver atoms, so that the impurity atoms bind to each other to form impurity grains among the silver atoms. In FIGS. 1 and 2, an amount of the impurity atoms is lower than that of the silver so that sizes of the impurity grains are negligible. Thus, during subsequent processes, the impurity grains function as a barrier between the silver atoms to prevent the silver atoms from binding to each other to form large silver grains.

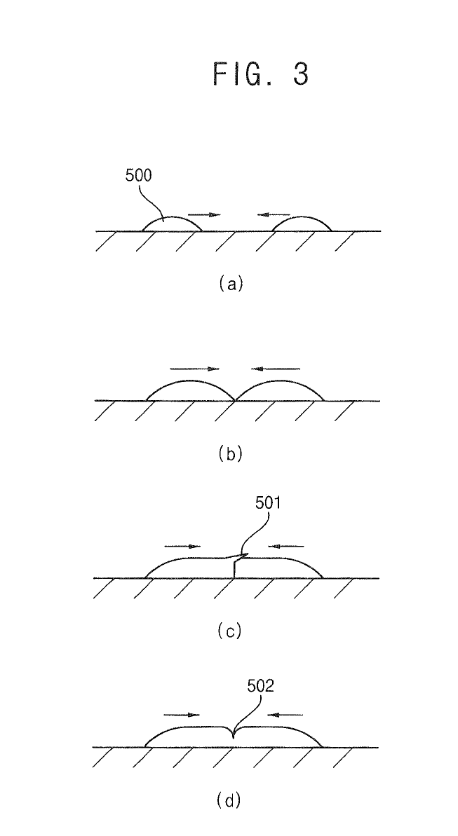

FIG. 3 is a cross-sectional view illustrating grains of silver.

Referring to FIG. 3, when a reflective electrode 250 includes silver, silver atoms are rearranged during subsequent processes to form a plurality of grains 500. Two adjacent grains 500 are combined to form a sharp protrusion 501 between the adjacent grains 500. The sharp protrusion 501 may be electrically connected to an opposite substrate 300, thereby forming a short circuit defect. In addition, the two adjacent grains 500 may be combined, and form a recess 502 between the adjacent grains 500, thereby forming a defect on the reflective electrode 250. Furthermore, an ambient light may be irregularly reflected from the sharp protrusion 501 and the recess 502 so that luminance is decreased. Thus, reflectivity of the reflective electrode 250 is decreased.

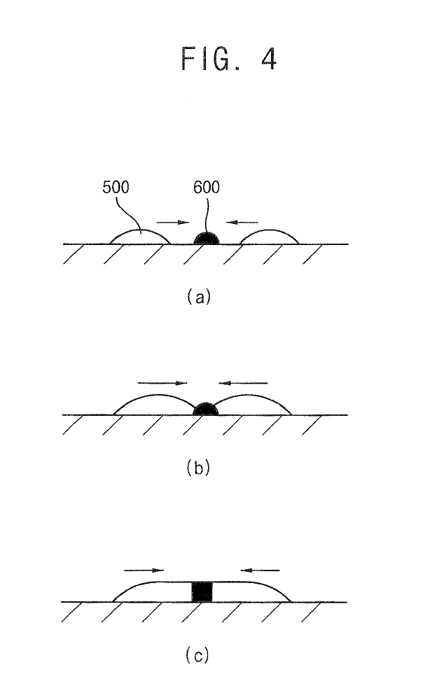

FIG. 4 is a cross-sectional view illustrating grains of a silver alloy including impurities at a low concentration, which has a low solubility in silver.

Referring to FIG. 4, when a reflective electrode 250 includes a silver alloy including silver and impurities that have a low solubility in the silver, an impurity grain 600 functions as a barrier between silver grains 500 so that the silver grains 500 may not be combined, thereby improving electrical and optical characteristics of the reflective electrode 250. In addition, although a temperature of subsequent processes is increased, the impurity grain 600 functions as the barrier to decrease a size of each of the silver grains 500. Thus, the reflective electrode 250 may have a uniform surface.

For example, the impurities of the silver alloy include a metal having a low solubility in the silver. The metal may include aluminum (Al), scandium (Sc), titanium (Ti), vanadium (V), chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), technetium (Tc), ruthenium (Ru), rhodium (Rh), palladium (Pd), cadmium (Cd), indium (In), tin (Sn), lanthanum (La), hafnium (Hf), tantalum (Ta), tungsten (W), rhenium (Re), osmium (Os), iridium (Ir), platinum (Pt), gold (Au), mercury (Hg), thallium (Tl), lead (Pb), bismuth (Bi), etc.

The-above listed metals can be used alone or in any combination to form the silver alloy. In addition, the silver alloy may include a metal halide, a metal sulfide, etc. These also can be used alone or in a combination thereof. An amount of the impurities is no less than an amount at which the impurities are mixed with the silver at a molecular level.

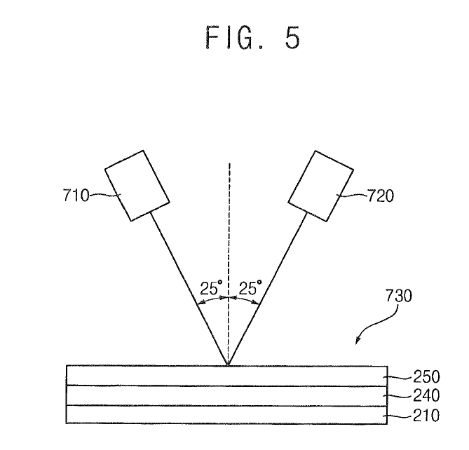

FIG. 5 is a cross-sectional view illustrating an apparatus for detecting reflectivity of a reflective electrode. Table 1 represents the reflectivity of the reflective electrode detected by the apparatus shown in FIG. 5.

Referring to FIG. 5, light generated from a light source 710 is irradiated onto a surface of a sample 730 at an incident angle of about 25°. The sample 730 includes a transparent electrode 240 and the reflective electrode 250. The transparent electrode 240 includes indium tin oxide (ITO). A photo detector 720 that formed an angle of about 25° with respect to a central line substantially perpendicular to the surface of the sample 730, detects reflected light that was reflected from the reflective electrode 250. The photo detector 720 is arranged substantially in symmetrical arrangement with respect to the light source 710. A thickness of the reflective electrode 250 is about 2,000 Å. In addition, the reflective electrode 250 is heat-treated at a temperature of about 250° C. for about one hour.

TABLE 1

| | Silver- | | | | Aluminum |
|---|---|---|---|---|---|
| | Molybdenum Alloy | | Silver | | Alloy |
| | After | After Heat | After | After Heat | After Heat |
| | Deposition | Treatment | Deposition | Treatment | Treatment |
| Example 1 | 93.8% | 99.6% | 99.0% | 55.0% | 92.0% |
| Example 2 | 95.2% | 97.9% | | | |
| Example 3 | 93.0% | 97.2% | | | |

Referring to Table 1, when the reflective electrode 250 includes an aluminum alloy, the reflectivity of the reflective electrode 250 including the aluminum alloy is about 92.0%. However, when the reflective electrode 250 includes pure silver having high reflectivity, the reflectivity before the heat treatment is about 99.0%, and the reflectivity after the heat treatment is about 55.0%. The reflectivity is greatly decreased after the heat treatment.

In Example 1 of Table 1, an amount of molybdenum in the silver-molybdenum alloy is about 1.1 wt %. In Example 2 of Table 1, an amount of molybdenum in the silver-molybdenum alloy is about 1.3 wt %. In Example 3 of Table 1, an amount of molybdenum in the silver-molybdenum alloy is about 1.5 wt %. The reflectivity of the reflective electrode 250 including the silver-molybdenum alloy is increased after the heat treatment. In particular, the reflectivity of the reflective electrode 250 including the silver-molybdenum alloy before the heat treatment is about 93% to about 95%, and the reflectivity of the reflective electrode 250 including the silver-molybdenum alloy after the heat treatment is about 97% to about 99%.

Therefore, before the heat treatment, the reflectivity of the reflective electrode 250 including the silver-molybdenum alloy is between that of the reflective electrode including the aluminum alloy and that of the reflective electrode including the pure silver. However, after the heat treatment, the reflectivity of the reflective electrode 250 including the silver-molybdenum alloy is greater than that of the reflective electrode including the aluminum alloy and that of the reflective electrode including the pure silver.

Alternatively, the impurities of the silver alloy may include a metal oxide having a low solubility in the silver. The metal oxide may include lithium oxide (LiO₂, Li₂O, Li₂O₂), beryllium oxide (BeO), sodium oxide (NaO₂, Na₂O, Na₂O₂), magnesium oxide (MgO, MgO₂), aluminum oxide (Al₂O₃), calcium oxide (CaO, CaO₂), scandium oxide (Sc₂O₃), titanium oxide (TiO, TiO₂, Ti₂O₃, Ti₃O₅), vanadium oxide (VO, VO₂, V₂O₃, V₂O₅), chromium oxide (CrO₂, CrO₃, Cr₂O₃, Cr₃O₄), manganese oxide (MnO, MnO₂), iron oxide (FeO, Fe₂O₃, Fe₃O₄), cobalt oxide (CoO, Co₃O₄), nickel oxide (NiO, Ni₂O₃), copper oxide (CuO, Cu₂O), zinc oxide (ZnO), niobium oxide (NbO, NbO₂), molybdenum oxide (MoO, MoO₂, MoO₃), palladium oxide (PdO, PdO₂), cadmium oxide (CdO), lead oxide (PbO, PbO₂), etc.

These can be used alone or in a combination thereof to form the silver alloy. An amount of the impurities is no less than an amount at which the impurities are mixed with the silver at a molecular level.

The impurities of the silver alloy may also include a nonmetal having a low solubility in the silver. The nonmetal may include boron (B), carbon (C), silicon (Si), phosphorus (P), sulfur (S), etc. These can be used alone of in a combination thereof.

Alternatively, the impurities of the silver alloy may also include a mixture of the metal and the nonmetal.

Referring again to FIGS. 1 and 2, the opposite substrate 300 includes an opposite transparent substrate 310, a color filter layer 320 and a common electrode 330. The opposite substrate 300 faces the display substrate 200.

The opposite transparent substrate 310 includes a transparent material that transmits light. For example, the opposite transparent substrate 310 includes a glass substrate.

The color filter layer 320 is formed on a surface of the opposite transparent substrate 310 facing the display substrate 100. The color filter layer 320 includes a red (R) color filter, a green (G) color filter and a blue (B) color filter. Alternatively, the color filter layer 320 may be formed on the display substrate 200.

The common electrode 330 is formed on the color filter layer 320 so that the common electrode 330 faces the transparent electrode 240 and the reflective electrode 250. The common electrode 330 includes a transparent conductive material. The common electrode 330 may include indium zinc oxide (IZO), indium tin oxide (ITO), etc.

The liquid crystal layer 400 includes liquid crystals arranged in a predetermined direction. The liquid crystal has electrical characteristics, such as anisotropy of dielectric constant and optical characteristics, such as anisotropy of refractivity. The arrangement of the liquid crystal varies in response to an electric field generated between the transparent electrode 240 and the common electrode 330, and thus a light transmittance of the liquid crystal layer 400 is changed.

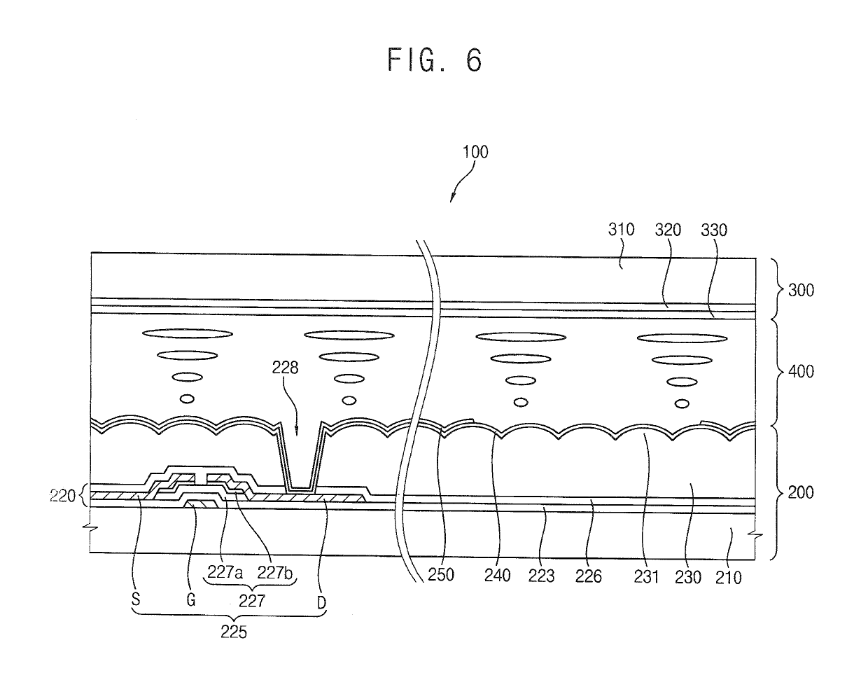

FIG. 6 is a cross-sectional view illustrating a display substrate in accordance with an embodiment of the present invention. The display substrate of FIG. 6 is substantially the same as in FIG. 2 except an organic insulating layer. Thus, the same reference numerals will be used to refer to the same or like parts as those described in FIG. 2.

Referring to FIG. 6, a plurality of microlenses 231 are formed on an upper surface of the organic insulating layer 230 to increase reflectivity against an ambient light. The microlenses 231 may be formed on the entire upper surface of the organic insulating layer 230. Alternatively, the microlenses 231 may be formed only on a reflection region RR. A reflective electrode 250 is formed in the reflection region RR.

Each of the microlenses 231 may have a convex lens that is protruded from the upper surface of the organic insulating layer 230. Alternatively, each of the microlenses 231 may have a concave lens that is recessed from the upper surface of the organic insulating layer 230. Each of the microlenses 231 may have a substantially circular shape, a polygonal shape, etc., when viewed on a plane.

Each of the transparent electrode 240 and the reflective electrode 250 has a constant thickness, and has substantially the same shape as the upper surface of the organic insulating layer 230. Thus, the reflective electrode 250 may have substantially the same profile as the microlenses 231.

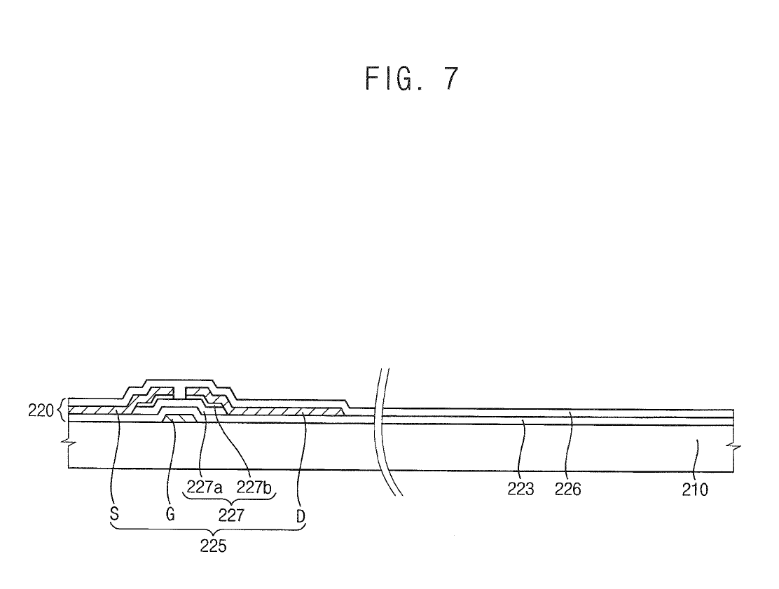

FIGS. 7 to 9 are cross-sectional views illustrating a method of manufacturing a display substrate in accordance with an embodiment of the present invention.

Referring to FIGS. 1 and 7, a pixel layer 220 is formed on a transparent substrate 210. The pixel layer 220 includes a plurality of pixel parts 221 arranged in a matrix. Each of the pixel parts 221 includes a transmission region TR and a reflection region RR.

Particularly, a first metal layer is deposited on the transparent substrate 210, and the first metal layer is patterned through a photolithography process to form a gate line 222 and a gate electrode G. The photolithography process includes an exposure process, a developing process, an etching process, etc.

A gate insulating layer 223 is formed on the transparent substrate 210 having the gate line 222 and the gate electrode G. The gate insulating layer 223 may include silicon nitride (SiNx), silicon oxide (SiOx), etc. A thickness of the gate insulating layer 223 may be about 4,500 Å.

An amorphous silicon (a-Si) layer and an n+ amorphous silicon (n+ a-Si) layer are formed on the gate insulating layer 223, preferably in sequence. The a-Si layer and the n+ a-Si layer are patterned through a photolithography process to form an active layer 227 overlapped with the gate electrode G. The photolithography process includes an exposure process, a developing process, an etching process, etc.

A second metal layer is deposited on the gate insulating layer 223 and the active layer 226, and the second metal layer is patterned through a photolithography process to form a data line 224, a source electrode S and a drain electrode D. The photolithography process includes an exposure process, a developing process, an etching process, etc.

An ohmic contact layer 227b interposed between the source and drain electrodes S and D are etched so that a semiconductor layer 227a between the source and drain electrodes S and D is exposed.

A passivation layer 226 is formed on the gate insulating layer 223 having the data line 224, the source electrode S and the drain electrode D. The passivation layer 226 includes an insulating material. The passivation layer 226 may include silicon nitride (SiNx), silicon oxide (SiOx), etc. For example, a thickness of the passivation layer 226 may be about 2,000 Å.

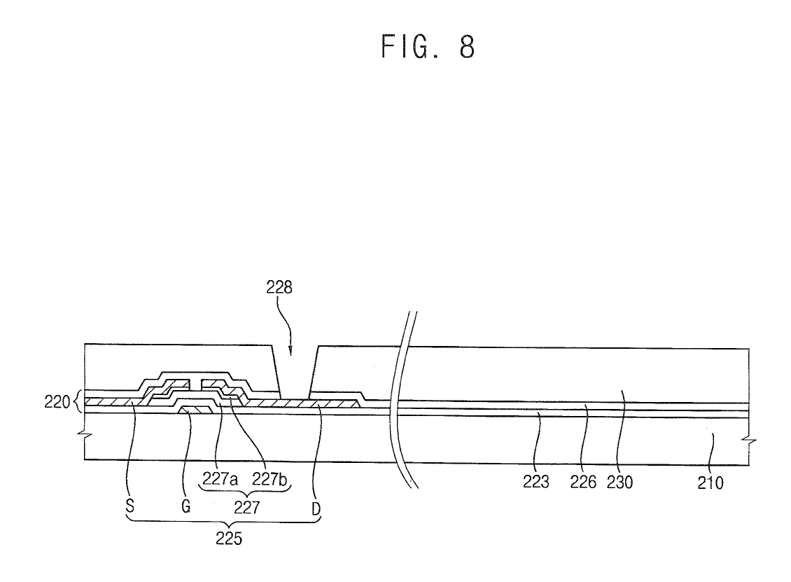

Referring to FIG. 8, an organic insulating layer 230 is formed on the pixel layer 220 to planarize the substrate. A contact hole 228 is formed through the organic insulating layer 230 and the passivation layer 226 using patterning processes that include an exposure process, a developing process, etc. In FIG. 8, the organic insulating layer 230 has a substantially flat surface. Alternatively, a plurality of microlenses may be formed on the organic insulating layer 230.

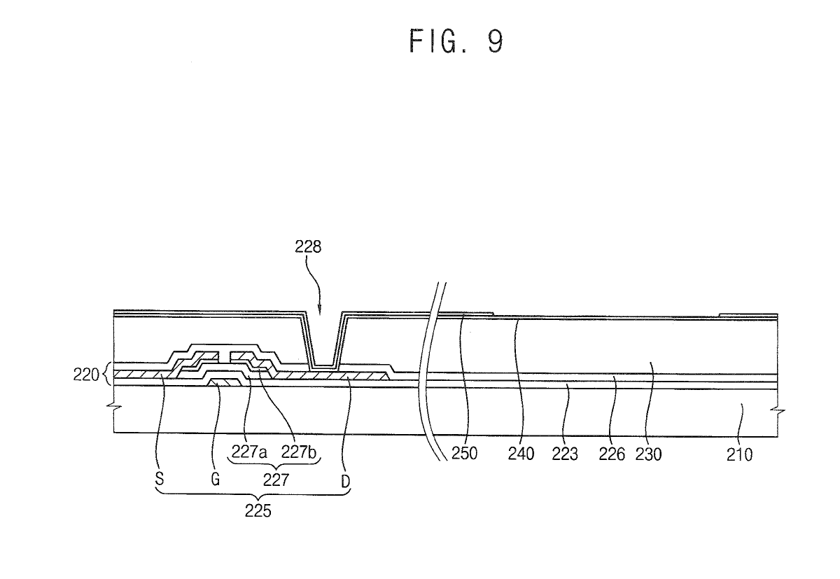

Referring to FIGS. 1 and 9, a transparent conductive layer is formed on the organic insulating layer 230. The transparent conductive layer is patterned to form a transparent electrode 240 through a photolithography process including an exposure process, a developing process, an etching process, etc. The transparent electrode 240 corresponds to each of pixel parts 221. The transparent electrode 240 is electrically connected to the drain electrode D of the thin-film transistor (TFT) 225 through the contact hole 228 that is formed through the organic insulating layer 230 and the passivation layer 226.

A silver alloy layer that includes silver and impurities having a low solubility in pure silver is deposited on the transparent electrode 240. The silver alloy layer is patterned to form a reflective electrode 250 through a photolithography process that includes an exposure process, a developing process, an etching process, etc. The reflective electrode 250 of FIG. 9 is substantially the same as in FIGS. 1 to 6. Thus, the same reference numerals will be used to refer to the same or like parts as those described in FIGS. 1 to 6.

According to at least one embodiment of the present invention, the reflective electrode includes the silver alloy that includes the silver and the impurities having a low solubility in the silver. The reflectivity of the reflective electrode is thereby increased, and the size of the silver grain is decreased, improving image display quality.

Although the illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A display substrate comprising:
a transparent substrate;
a pixel layer formed on the transparent substrate, the pixel layer having a plurality of pixel parts, each of the pixel parts including a transmission region and a reflection region;
an organic insulating layer formed on the pixel layer;
a transparent electrode formed on the organic insulating layer corresponding to each of the pixel parts; and
a reflective electrode formed on the transparent electrode corresponding to the reflection region, the reflective electrode including a silver alloy that includes silver (Ag) and impurities having a low solubility in silver,
wherein the impurities form impurity grains between silver atoms to prevent the silver atoms from binding to each other to form large silver grains,
wherein the impurities comprise a metal oxide.

2. The display substrate of claim 1, wherein the metal oxide comprises a material selected from the group consisting of lithium oxide (LiO₂, Li₂O, Li₂O₂), beryllium oxide (BeO), sodium oxide (NaO₂, Na₂O, Na₂O₂), magnesium oxide (MgO, MgO₂), aluminum oxide (Al₂O₃), calcium oxide (CaO, CaO₂), scandium oxide (Sc₂O₃), titanium oxide (TiO, TiO₂, Ti₂O₃, Ti₃O₅), vanadium oxide (VO, VO₂, V₂O₃, V₂O₅), chromium oxide (CrO₂, CrO₃, Cr₂O₃, Cr₃O₄), manganese oxide (MnO, MnO₂), iron oxide (FeO, Fe₂O₃, Fe₃O₄), cobalt oxide (CoO, Co₃O₄), nickel oxide (NiO, Ni₂O₃), copper oxide (CuO, Cu₂O), zinc oxide (ZnO), niobium oxide (NbO, NbO₂), molybdenum oxide (MoO, MoO₂, MoO₃), palladium oxide (PdO, PdO₂), cadmium oxide (CdO) and lead oxide (PbO, PbO₂).

3. The display substrate of claim 1, wherein a thickness of the reflective electrode is about 2,000 Å to about 3,000 Å.

4. The display substrate of claim 1, wherein a microlens is formed on the organic insulating layer.

5. The display substrate of claim 1, wherein the impurities further comprise a metal.

6. The display substrate of claim 5, wherein the metal comprises a material selected from the group consisting of scandium (Sc), vanadium (V), chromium (Cr), iron (Fe), cobalt (Co), nickel (Ni), gallium (Ga), yttrium (Y), niobium (Nb), technetium (Tc), ruthenium (Ru), lanthanum (La), hafnium (Hf), tantalum (Ta), tungsten (W), rhenium (Re), osmium (Os), iridium (Ir), mercury (Hg), thallium (Tl), lead (Pb) and bismuth (Bi).

7. A display substrate comprising:
a transparent substrate;
a pixel layer formed on the transparent substrate, the pixel layer having a plurality of pixel parts, each of the pixel parts including a transmission region and a reflection region;
an organic insulating layer formed on the pixel layer;
a transparent electrode formed on the organic insulating layer corresponding to each of the pixel parts; and
a reflective electrode formed on the transparent electrode corresponding to the reflection region, the reflective electrode including a silver alloy that includes silver (Ag) and impurities having a low solubility in silver,
wherein the impurities form impurity grains between silver atoms to prevent the silver atoms from binding to each other to form large silver grains, wherein the impurities comprise a nonmetal.

8. The display substrate of claim 7, wherein the nonmetal comprises a material selected from the group consisting of boron (B), carbon (C), silicon (Si), phosphorus (P) and sulfur (S).

9. The display substrate of claim 7, wherein a thickness of the reflective electrode is about 2,000 Å to about 3,000 Å.

10. The display substrate of claim 7, wherein a microlens is formed on the organic insulating layer.

11. A method of manufacturing a display substrate, comprising:
forming a pixel layer including a plurality of pixel parts on a transparent substrate, each of the pixel parts including a transmission region and a reflection region;
forming an organic insulating layer on the pixel layer;
forming a transparent electrode on the organic insulating layer corresponding to each of the pixel parts; and
forming a reflective electrode in the reflection region, the reflective electrode including a silver alloy that includes silver and impurities having a low solubility in silver,
wherein the impurities form impurity grains between silver atoms to prevent the silver atoms from binding to each other to form large silver grains,
wherein the impurities comprise a metal oxide or a nonmetal.

12. The method of claim 11, wherein the nonmetal comprises a material selected from the group consisting of boron (B), carbon (C), silicon (Si), phosphorus (P) and sulfur (S).

13. The method of claim 11, wherein the metal oxide comprises a material selected from the group consisting of lithium oxide (LiO₂, Li₂O, Li₂O₂), beryllium oxide (BeO), sodium oxide (NaO₂, Na₂O, Na₂O₂), magnesium oxide (MgO, MgO₂), aluminum oxide (Al₂O₃), calcium oxide (CaO, CaO₂), scandium oxide (Sc₂O₃), titanium oxide (TiO, TiO₂, Ti₂O₃, Ti₃O₅), vanadium oxide (VO, VO₂, V₂O₃, V₂O₅), chromium oxide (CrO₂, CrO₃, Cr₂O₃, Cr₃O₄), manganese oxide (MnO, MnO₂), iron oxide (FeO, Fe₂O₃, Fe₃O₄), cobalt oxide (CoO, Co₃O₄), nickel oxide (NiO, Ni₂O₃), copper oxide (CuO, Cu₂O), zinc oxide (ZnO), niobium oxide (NbO, NbO₂), molybdenum oxide (MoO, MoO₂, MoO₃), palladium oxide (PdO, PdO₂), cadmium oxide (CdO) and lead oxide (PbO, PbO₂).
